(19) United States
(12) Patent Application Publication
(10) Pub. No.: US 2006/0048066 A1
(43) Pub. Date: Mar. 2, 2006

(54) System for digital network communications in public places

(76) Inventor: Thomas O'Rourke, Seattle, WA (US)

Correspondence Address: GRAYBEAL, JACKSON, HALEY LLP, 155 - 108TH AVENUE NE, SUITE 350, BELLEVUE, WA, 98004-5901, US

(21) Appl. No.: 11/211,991

(22) Filed: Aug. 24, 2005

Related U.S. Application Data
(60) Provisional application No. 60/604,365, filed on Aug. 24, 2004.

(51) Int. Cl. G06F 3/00

(52) U.S. Cl. 715/764; 715/700

(57) ABSTRACT

An improvement to electronic displays of information in public places such as transportation terminals and retail stores. The system includes combinations of fixed display screens as well as personal devices such as portable computers communicating via radio networks and portable telephones communicating via telephone messaging protocols. The radio broadcasts to portable computers and telephones are tailored to the specific location, either the entire public facility or some sub-portion of the facility. When sub-portions of the facility receive different radio communications directed to wireless computers and mobile telephones, the fixed display screens in sub-locations also receive customized content particular to the sub-location.

### BACKGROUND

For decades, airports and other transportation terminals have used electronic displays served by computers to show information about arrivals and departures. The information displayed is particular to the entire station or to some sub-portion of the station such as a particular carrier or gate.

For decades, it has been known to present video displays in retail establishments open to the public for giving them information about products or services they can buy from the establishment.

### SUMMARY OF THE INVENTION

The system is an improvement to electronic displays of information in public places such as transportation terminals and retail stores. The system takes advantage of improvements in networking technology between a central hub and individual display devices. The system includes combinations of fixed display screens as well as personal devices such as portable computers communicating via radio networks and portable telephones communicating via telephone messaging protocols. The radio broadcasts to portable computers and telephones are tailored to the specific location, either the entire public facility or some sub-portion of the facility. When sub-portions of the facility receive different radio communications directed to wireless computers and mobile telephones, the fixed display screens in sub-locations also receive customized content particular to the sub-location. Each fixed display screen has a network address that is used to direct content to the screen.

In another aspect, the system presents a mixture of general content obtained from the global computer network (Internet) plus content which is specific to the location or sub-location or particular fixed display. By allowing this mixture of content, the system can present information of interest to people throughout the country or throughout the world as well as content of interest only to people in that particular location or sub-location.

In another aspect, the system allows a combination of content dissemination to multiple members of the public within the facility as well as allowing interactive communications so that an individual member of the public can make menu choices or present queries which control the content that is presented in a part of the screen. This combination of one-way content delivery plus interactive two-way communication is presented via each of the display types, the fixed display screens which are mounted in kiosks with user input devices, as well as the personal portable devices such as personal computers with wireless network connections and mobile telephones with messaging capabilities.

In another aspect, the fixed display screens which are mounted in kiosks present the information in a way that is organized to maximize utility to both a single person undertaking interactive communications as well as to others who may be viewing the display at the same time. The display is preferably taller than it is wide. An upper portion of the display presents information of general interest to people in the area, including both information to people anywhere in the country or region as well as information specific to the particular location of the display. At the same time, a bottom portion of the screen handles interactive communications with a single viewer who controls what information is displayed. The user input can be via touch screen or keyboard or any other user input method.

### BRIEF DESCRIPTION OF THE DRAWINGS

FIG. 1 is a network diagram showing the three possible display output systems and various input systems.

FIG. 2 shows the fixed display screen of a kiosk as divided into an interactive area and an area for display to all nearby viewers.

### DETAILED DESCRIPTION

The features of the present invention which are believed to be novel are set forth with particularity in the appended claims. Aspects of the invention may best be understood by making reference to the following description taken in conjunction with the accompanying drawings.

The system may be implemented using the Internet protocol for networking. Each fixed display screen at a kiosk is driven by an embedded personal computer with a wired or wireless Internet protocol connection to a network.

Radio transceiver access points for radio network communication with portable computers may be located throughout the facility with strategic placement and adjustment of signal strength so that a portable computer will receive information relevant to a sub-location as desired rather then communicating with a wireless transceiver for a different sub-location within the facility. The radio transceiver access points may use 802.11 Wi Fi protocol or Bluetooth protocol.

For mobile telephones, SMS messaging, or other cellular telephone digital data protocol may be used as the communication protocol. The fixed kiosk displays or other signs may tell members of the public how to use their telephones to receive the information which is broadcast from local mobile telephone antennas. Again, careful attention to placement of antennas and their power can insure that people receive information specific to their location within the facility.

When a member of the public connects to the system via a mobile telephone or a wireless computer, the system captures information about the communication for subsequent reporting. Similar information is captured when a member of the public provides interactive user input at a kiosk.

The central system may be configured with one system server having a connection to the Internet with as many personal computer terminals as necessary for generation and delivery of content and for administration. The server system delivers content to all display devices. However, user interactivity which extends to the Internet is controlled and filtered to block the delivery of undesired pop-up advertising and any other undesired user interaction. Access to undesired web sites is blocked.

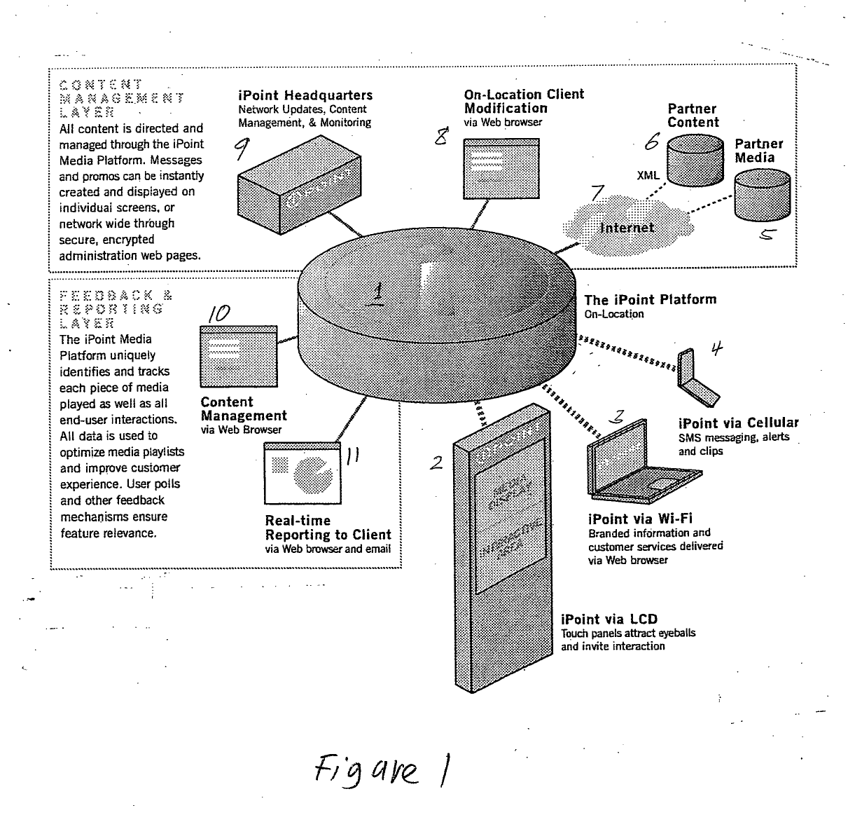

A shown in FIG. 1, the hub 1 is the central server. It provides information to kiosk displays 2 as well as to portable computers 3 and mobile telephones 4. Media content, including advertising, is obtained from an Internet video content server 5 and from an XML data server 6 which are both coupled via the Internet 7. The system can be administered via password-protected logon from any kiosk or personal computer with a modification user interface 8 using a standard web browser. Alternatively, the system can be managed, monitored, or updated from a headquarters 9. The content that is presented to members of the public may be managed from a personal computer with a content management user interface 10 via a web browser. The system will generate and produce reports which may be viewed via a web browser user interface 11 or email.

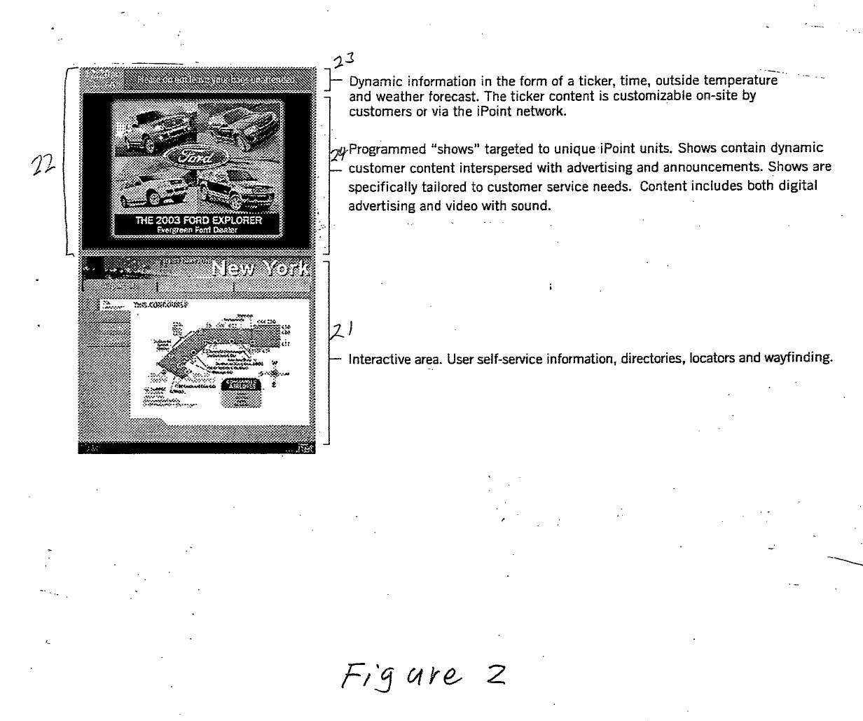

As shown in FIG. 2, the kiosk display includes an interactive area 21 as well as a general information display area 22. In some embodiments, the general information display area is further subdivided into a banner of text information, referred to as a ticker 23, which may be placed at the top of the screen, and an image portion 24, which may be a still image or a moving image. The image portion may be used to present program “shows” which maybe interspersed with advertising.

Although the interactive portion of the display and the associated user input may be set up as a separate and distinct system from the general display portion 22, synergies are achieved by placing the two adjacent to each other, preferably over/under. The over/under configuration may be achieved with two standard display monitors one mounted above the other. However, further synergies are achieved by using a single tall display screen as shown in FIG. 2. One of the synergies is that the display screen can be used for a single very large message when desired.

In public places like transportation terminals, the interactive area may be used for:
Maps/way finding
Directories/services
Schedules for conference rooms and similar facilities
Attractions
Contact Information
Local news
Local traffic
Local and destination city information
Local and destination current weather and 5-day forecast
   For use in retail stores, the interactive area may include:
Product finders
In-store specials
Co-op advertising
Store information
Calendars and events

As shown in FIG. 2, a top banner of the screen may have text information such as the current time and temperature and a continuously scrolling text ticker display of short text messages. The text may scroll from right to left and present any messages that an administrator of the facility wishes to deliver to individuals passing the kiosk at that time and place.

The largest portion of the general information part of the display is for presentation of images 24. In one embodiment, the system is programmed to present “shows” specifically tailored to customer service needs. In one embodiment, the system supports flash movies, windows media video, static images, and custom text messages via flash. The content may be organized into timed “spots” such as one-minute feature shows, 30-second video commercials, 15-second still or animated information or ads, and 10-second announcements, with a 2-second fade out/fade in screen between each show.

When no one has touched the user input features of the kiosk for a defined amount of time, the system will be capable of running full screen displays to take advantage of the full screen size.

An emergency messaging function will allow an administrator to override the media presentation in the image portion of the screen 24 or in the entire screen. When the emergency message is activated by an administrator, all display kiosks specified by the administrator will display the emergency message. The administrator user interface will include a menu presenting possible messages to be displayed and a choice of background colors. The user will be able to edit or add to any message presented via the menu.

Additional administration user interface components allow the following functionality:
a.) Customization of messages for use between show elements in the media play list
b.) Create/edit/delete text ticker
c.) Create/edit/delete individual play list
d.) Create/edit/delete play list schedules
e.) Assign/edit/delete play list schedule for specific displays
f.) Assign/edit/delete emergency messages
g.) Activate/deactivate emergency messages
h.) Presentation of error messages
i.) Add/edit/delete registered system display clients
j.) Add/edit/delete permitted users

Because many varying and different embodiments may be made within the scope of the inventive concept herein taught, including equivalent structures or designs hereafter thought of, and because many modifications may be made in the embodiments herein detailed, the details herein are to be interpreted as illustrative and not in a limiting sense. Rather, the invention is defined by the following claims.

What is claimed:

1. A display and user input system for public places, comprising:
(a) within a public place, a plurality of display screens driven to display coordinated information by a set of one or more servers coupled to the display screens;
(b) each display screen being driven, at a single point in time, in one of two alternative modes, the modes comprising:
(1) a user interaction mode where a lower portion of the screen displays information for use by a single user who provides input to the system by selecting hotspots within the lower portion and an upper portion displays information for viewing by other persons; and
(2) full screen display mode where essentially the entire screen displays a unified image for viewing by a plurality of people.

2. The system of claim 1 where each display screen is driven such that, when the screen is in user interaction mode and no user input has been received via a hot spot in the lower portion for a defined amount of time, the screen automatically switches to full screen display mode.

3. A display system for public places, comprising:
(a) within a public place, a plurality of display screens driven to display coordinated information by a set of one or more servers coupled to the display screens; and
(b) within the public place, a plurality of network radio access point antennas, coupled to the set of one or more servers which receive, for each portable network radio communication device which connects to an antenna, an identifier of the antenna associated with an identifier for the portable network radio communication device;
where the system simultaneously provides:
(c) a first message to a first display screen;
(d) the first message to a portable network radio communication device coupled to a radio access point near the first display screen;
(e) a second message to a second display screen; and
(d) the second message to a portable network radio communication device coupled to a radio access point near the second display screen.

4. The method of claim 3 where the access point antennas operate with an 802.11 WiFi protocol.

5. The method of claim 3 where the access point antennas operate with a cellular telephone digital data protocol.

6. The method of claim 5 where the access point antennas operate with an SMS cellular telephone digital data protocol.

7. The method of claim 3 where the access point antennas operate with a Bluetooth protocol.
